(19) United States
(12) Patent Application Publication
(10) Pub. No.: US 2021/0063925 A1
(43) Pub. Date: Mar. 4, 2021

(54) IMAGE FORMING APPARATUS

(71) Applicant: KONICA MINOLTA, INC., Tokyo (JP)

(72) Inventor: Hiroshi ASO, Tokyo (JP)

(21) Appl. No.: 17/009,310

(22) Filed: Sep. 1, 2020

(30) Foreign Application Priority Data
Sep. 4, 2019 (JP) 2019-160868

(51) Int. Cl. G03G 15/20

(52) U.S. Cl. CPC G03G 15/2039; G03G 15/2028

(57) ABSTRACT

An image forming apparatus forms an image on a continuous medium, fixes the image by a fixing unit, and winds the continuous medium. The fixing unit has a first rotating member on a fixing surface side of the continuous medium and a second rotating member facing the first rotating member. The first rotating member is separate from the continuous medium when tension is applied to the continuous medium while the first rotating member is separate from the second rotating member. The image forming apparatus includes a tension applying mechanism, upstream and downstream nip portions, and a controller. The controller separates the first rotating member from the second rotating member while tension is applied to the continuous medium, and rotates the first rotating member. During a temperature raising operation and a temperature maintaining operation, the controller causes the nip portions to be in pressing states and maintains the tension.

### CROSS-REFERENCE TO RELATED APPLICATIONS

The present application claims priority under 35 U.S.C. § 119 to Japanese Patent Application No. 2019-160868 filed on Sep. 4, 2019, the entire content of which is incorporated herein by reference.

### TECHNOLOGICAL FIELD

The present invention relates to an image forming apparatus.

### DESCRIPTION OF RELATED ART

When an electrophotographic image forming apparatus that forms an image on a continuous form medium (roll sheet, continuous form, etc.) is not forming an image such as in a standby state, the continuous recording medium exists in the conveyance route while being stopped. Particularly, when the continuous recording medium is nipped in the fixing nip while the continuous recording medium is stopped during the temperature raising operation of the fixing unit before the start of image formation or after the completion of image formation, discoloration (burning) or deformation occurs. Therefore, the fixing surface side member and the back surface side member of the fixing unit are separate from each other. However, when the distance between the fixing surface side member and the back surface side member is small, the continuous form medium is deformed by the heat from the fixing surface side member. As a result, the fixing surface side member comes into contact with the continuous form media and is scratched particularly when the fixing surface side member is rotated for uniform heating. As a result, the image quality is deteriorated.

In order to solve such a problem, there has been proposed a method including movement of the continuous form medium during a temperature raising operation of a fixing unit (for example, see JP-A-2016-180925).

In an alternative method, the distance between the fixing surface side member and the back surface side member is increased during the temperature raising operation of the fixing unit, a tension applying device applies tension to the continuous recording medium, and the continuous recording medium is wound around the rear surface member. By this method, it is possible to prevent the fixing surface side member from being scratched due to the deformation of the continuous recording medium due to heat.

### SUMMARY

When the continuous form medium is cut after printing and the printed matter is taken out or when the roll of the continuous form medium on the feeding side is replaced, it is necessary to relax the tension applied by the tension applying device to the continuous form medium. However, when the tension is relaxed in the method of applying tension to the continuous form medium and winding it around the back side member, the continuous form medium cannot keep wound around the back side member, and it becomes impossible to maintain the distance between the continuous form medium and the fixing surface side member. Therefore, when the printed matter is taken out or the roll of continuous sheet media on the feeding side is replaced, it is necessary to stop the temperature raising operation and the temperature maintaining operation of the fixing unit. Therefore, there is a problem that a waiting time is required for the temperature raising operation of the fixing unit for subsequent reprinting.

An object of the present invention is to shorten the waiting time of the temperature raising operation of the fixing unit in the image forming apparatus after cutting the continuous medium after printing to take out the printed matter or after replacing the roll of the continuous medium on the paper feeding side.

To achieve at least one of the abovementioned objects, according to an aspect of the present invention, there is provided an image forming apparatus that forms an image on a continuous medium fed from a sheet feeder, fixes the image by a fixing unit, and winds the continuous medium at a winder,

the fixing unit having a first rotating member and a second rotating member, the first rotating member being provided on a fixing surface side of the continuous medium, the second rotating member facing the first rotating member across a sheet passing path of the continuous medium,

the first rotating member being set to be separate from the continuous medium in the sheet passing path in response to tension applied to the continuous medium while the first rotating member is separate from the second rotating member,

the image forming apparatus including:

a tension applying mechanism that applies tension to the continuous medium;

at least one paired upstream nip portion arranged at an upstream side of the fixing unit and at a downstream side of the sheet feeder in the sheet passing path;

at least one paired downstream nip portion arranged at a downstream side of the fixing unit and at an upstream side of the winder in the sheet passing path; and

a controller that separates the first rotating member from the second rotating member while tension is applied to the continuous medium, rotates the first rotating member, and performs a temperature raising operation and a temperature maintaining operation of the first rotating member,

wherein, during the temperature raising operation and the temperature maintaining operation, the controller causes the upstream nip portion to be in a pressing state and the downstream nip portion to be in a pressing state and maintains tension that is applied to the continuous medium between the upstream nip portion and the downstream nip portion.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram showing an example of an overall configuration of an image forming apparatus according to a first embodiment;

FIG. 2 is a block diagram showing an example of a functional configuration of the image forming apparatus in FIG. 1;

FIG. 3 is a diagram showing an example of a configuration of a tension applying mechanism;

FIG. 4 is a diagram showing an example of a configuration of a fixing unit;

FIG. 5 is a flowchart showing temperature raising control processing performed by a controller in FIG. 2;

FIG. 6 is a diagram showing a state of the image forming apparatus in a temperature raising operation and a temperature maintaining operation; and

FIG. 7 is a diagram showing an example of an overall configuration of an image forming apparatus according to a second embodiment.

### DETAILED DESCRIPTION OF THE EMBODIMENTS

Hereinafter, one or more embodiments of the medical information management system according to the present invention will be described with reference to the drawings. However, the scope of the present invention is not limited to the disclosed embodiments or illustrated examples.

### First Embodiment

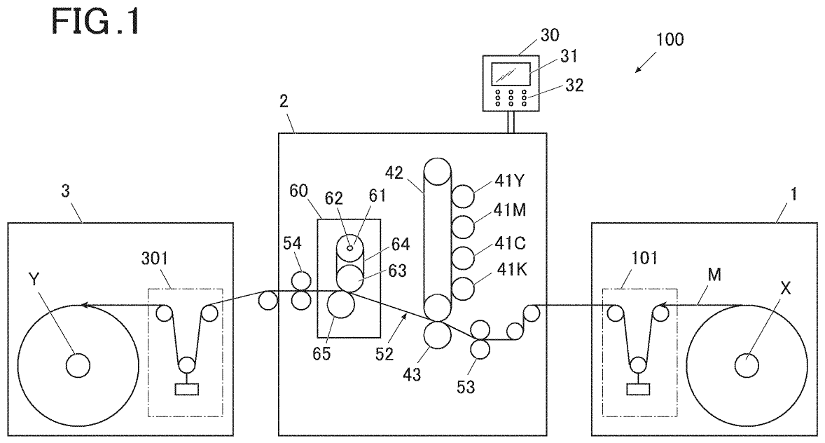

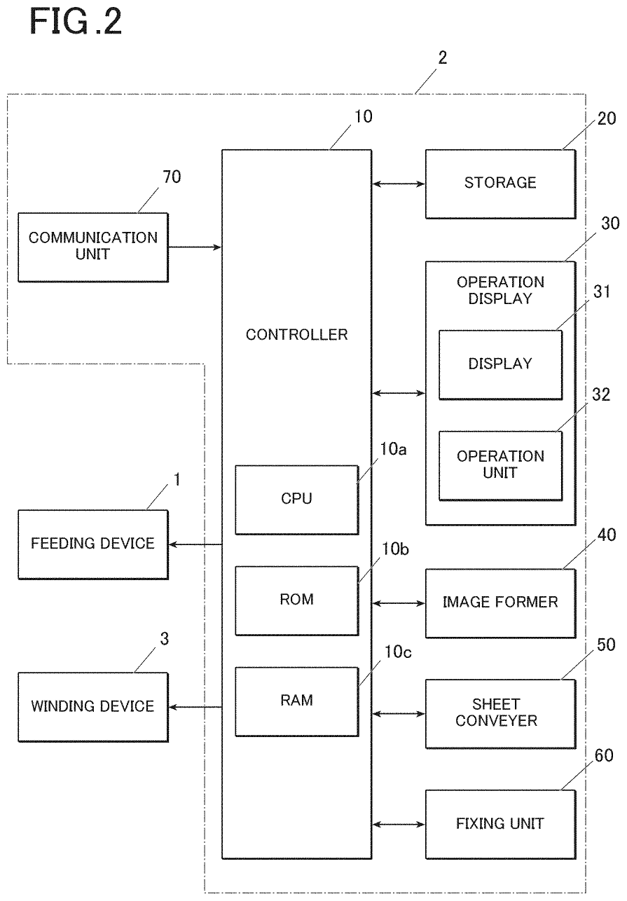

FIG. 1 is a diagram showing an example of an overall configuration of the image forming apparatus 100 according to a first embodiment. FIG. 2 is a diagram showing a main part of a control system of the image forming apparatus 100. The image forming apparatus 100 is, for example, an apparatus that forms an image on a continuous form medium M such as a roll sheet or a continuous form.

As shown in FIG. 1, the image forming apparatus 100 is configured by connecting a feeding device (sheet feeder) 1, a main body 2, and a winding device (winder) 3 from the upstream side along the conveyance direction (sheet conveyance direction) of the continuous medium M. FIG. 1 shows an example where the feeding device 1 and the winding device 3 are formed separately from the main body portion 2, but they may be formed integrally.

The feeding device 1 is a device that feeds the continuous recording medium M to the main body 2. The feeding device 1 drives a motor (not shown) so as to convey the continuous medium M that is wound around a support shaft X to the main body 2 at a constant rate. The operation of the motor of the feeding device 1 is controlled by a controller 10 included in the main body 2.

Further, the feeding device 1 is provided with a tension applying mechanism 101 that applies tension to the continuous medium M.

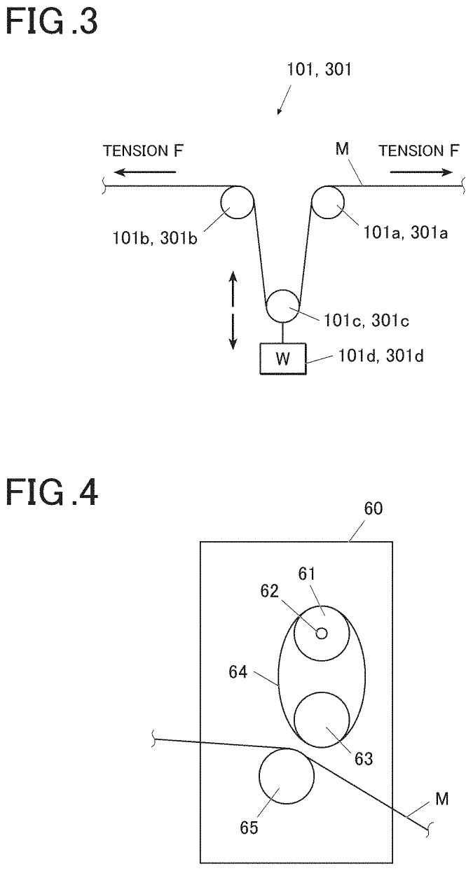

FIG. 3 is a diagram showing the configuration of the tension applying mechanism 101. As shown in FIG. 3, the tension applying mechanism 101 includes driven rollers 101a, 101b, a dancer roller 101c, a weight 101d, and the like.

The fed continuous medium M is wound around the driven roller 101a, the dancer roller 101c, and the driven roller 101b and passed through the main body 2. The dancer roller 101c includes a weight 101d, and the load thereof is applied to the continuous medium M as tension F. The dancer roller 101c is driven and rotates in either direction. The dancer roller 101c is supported so as to be movable in the vertical direction, and the movable range in the vertical direction is restricted. The controller 10 controls the rates of the motors of the feeding device 1 and the winding device 3 so that the dancer roller 101c is located within a certain range (that is, a certain tension is applied to the continuous medium M). When the power of the image forming apparatus 100 is turned off, the motors of the feeding device 1 and the winding device 3 are also not energized. Therefore, the dancer roller 101c falls by its own weight to the lower limit of the movable range, and tension is not applied to the continuous medium M. Instead of the load of the weight 101d, an air cylinder or the like may be used to apply a load to the dancer roller 101c, and the pressure may be controlled to apply a constant load.

The main body 2 forms an image on the continuous medium M fed from the feeding device 1 by an intermediate transfer method using the electrophotographic process technology.

As shown in FIG. 2, the main body 2 includes a controller 10, a storage 20, an operation display 30, an image former 40, a sheet conveyer 50, a fixing unit 60, a communication unit 70, and the like.

The controller 10 includes a CPU (Central Processing Unit) 10a, a ROM (Read Only Memory) 10b, a RAM (Random Access Memory) 10c, and the like. The CPU 10a reads out a program corresponding to the processing content from the ROM 10b, loads it in the RAM 10c, and cooperates with the loaded program to integrally control the operation of each part of the main body 2, the feeding device 1, the winding device 3, and the like.

The storage 20 includes, for example, a nonvolatile semiconductor memory (so-called flash memory), a hard disk drive, or the like. The storage 20 stores input document data, various setting information, image data, and the like. The data and the like may be stored in the RAM 10c of the controller 10.

The operation display 30 includes, for example, a liquid crystal display (LCD) with a touch panel, and functions as a display 31 and an operation unit 32.

The display 31 displays various operation screens, image states, operating conditions of each function, and the like in accordance with display control signals input from the controller 10.

The operation unit 32 includes various operation keys such as numeric keys and a start key, receives various input operations by the user, and outputs operation signals to the controller 10.

The image former 40 forms toner images of Y (yellow), M (magenta), C (cyan), and K (black) on the photosensitive drums 41Y, 41M, 41C, and 41K, for example, based on image data that is input from an external device (personal computer or the like) via the communication unit 70. The image former 40 performs primary transfer in which the toner images of the four colors are sequentially stacked on the intermediate transfer belt 42 and then secondary transfer in which an image is formed (printed) on the continuous medium M that is fed from the feeding device 1 by the transfer rollers 43.

The sheet conveyer 50 has a sheet passing path 52 including a plurality of conveying rollers.

The sheet conveyer 50 conveys, on the basis of the control of the controller 10, the continuous medium M that has been conveyed from the feeding device 1 to the main body 2 to the image former 40 and conveys the continuous medium M on which the toner image has been formed in the image former 40 to the fixing unit 60. Then, the continuous medium M on which the toner image has been fixed in the fixing unit 60 is conveyed to the winding device 3.

In the present embodiment, at least a pair of nip rollers (a roller nip) 53 are provided in the sheet passing path 52, at the upstream side of the fixing unit 60 and the downstream side of the feeding device 1. Further, at least a pair of nip rollers (a roller nip) 54 are provided at the downstream side of the fixing unit 60 and at the upstream side of the winding device 3. The roller nips 53, 54 can be in respective pressing states and in respective separating states using a pressing drive mechanism. Because both the roller nips 53, 54 are in respective pressing states while tension is applied to the continuous medium M by the tension applying mechanism 101 and the tension applying mechanism 301, the tension applied to the continuous medium M between the roller nip 53 and the roller nip 54 can be maintained even if the rotation of the rollers is stopped and the tension applying mechanisms 101, 301 relax the tension.

The paper passing path 52 is set such that, in response to tension applied to the continuous medium M while the fixing belt 64 of the fixing unit 60 and the lower pressing roller 65 are separate from each other, the fixing belt 64 and the continuous medium M are separate from each other. At this time, as shown in FIG. 4, when the paper passing path 52 is set such that the continuous medium M is wound around the lower pressing roller 65, the continuous medium M is pulled by the tension and follows the lower pressing roller 65. Therefore, the deformation of the continuous medium M due to heat during the temperature raising operation or the temperature maintaining operation is easily corrected.

The fixing unit 60 fixes the toner image on the continuous medium M by heating and pressing the continuous medium M on which the toner image is formed at the fixing nip.

FIG. 4 is a schematic diagram showing a configuration of the fixing unit 60. As shown in FIG. 4, the fixing unit 60 includes a heating roller 61, a heating source 62 that heats the heating roller 61, an upper pressing roller 63, a fixing belt 64 (first rotating member) that is an endless belt hung across the heating roller 61 and the upper pressing roller 63, and a lower pressing roller 65 (second rotating member). The heating roller 61, the heating source 62, the upper pressing roller 63, and the fixing belt 64 are provided on the fixing surface side of the continuous medium M. The lower pressing roller 65 is provided so as to face the fixing belt 64 with the sheet passing path 52 of the continuous medium M interposed therebetween (that is, on the back surface side of the continuous medium M). There may be a heating source that heats the lower pressing roller 65.

The lower pressing roller 65 is configured to be movable, and the upper pressing roller 63 and the lower pressing roller 65 can press on and separate from each other by driving a pressing drive mechanism (not shown). As the upper pressing roller 63 and the lower pressing roller 65 press on and are separate from each other, the fixing belt 64 and the lower pressure roller 65 can press on and be separate from each other. When the fixing belt 64 and the lower pressure roller 65 press on each other, a fixing nip that pinches and conveys the continuous medium M is formed. The continuous medium M is heated and pressurized when passing through the fixing nip formed by the fixing belt 64 heated by the heating source 62 and the lower pressure roller 65. In this way, the toner image is fixed.

The communication unit 70 includes a communication control card such as a LAN (Local Area Network) card, and sends and receives various kinds of data to and from an external device (for example, a personal computer) connected to a communication network such as a LAN and a WAN (Wide Area Network).

The winding device 3 is a device that winds the continuous medium M conveyed from the main body 2. The winding device 3 drives a motor (not shown) to wind the continuous medium M conveyed from the main body 2 around the support shaft Y at a constant rate. The controller 10 in the main body 2 controls the winding operation of the winding device 3.

Further, the winding device 3 is provided with a tension applying mechanism 301 that applies a tension to the continuous medium M. As shown in FIG. 3, the tension applying mechanism 301 includes driven rollers 301a, 301b, a dancer roller 301c, a weight 301d, and the like. The continuous medium M conveyed from the main body 2 is wound around the driven roller 301a, the dancer roller 301c, and the driven roller 301b, tension is applied, and then the continuous medium M is conveyed to the support shaft Y. The mechanism of applying tension by the tension applying mechanism 301 is the same as that by the tension applying mechanism 101, and thus the description is omitted.

In the present embodiment, the tension applying mechanism is provided in both the feeding device 1 and the winding device 3, but may be provided in only one of them.

(Operation of Image Forming Apparatus 100)

Next, the operation of the image forming apparatus 100 will be described.

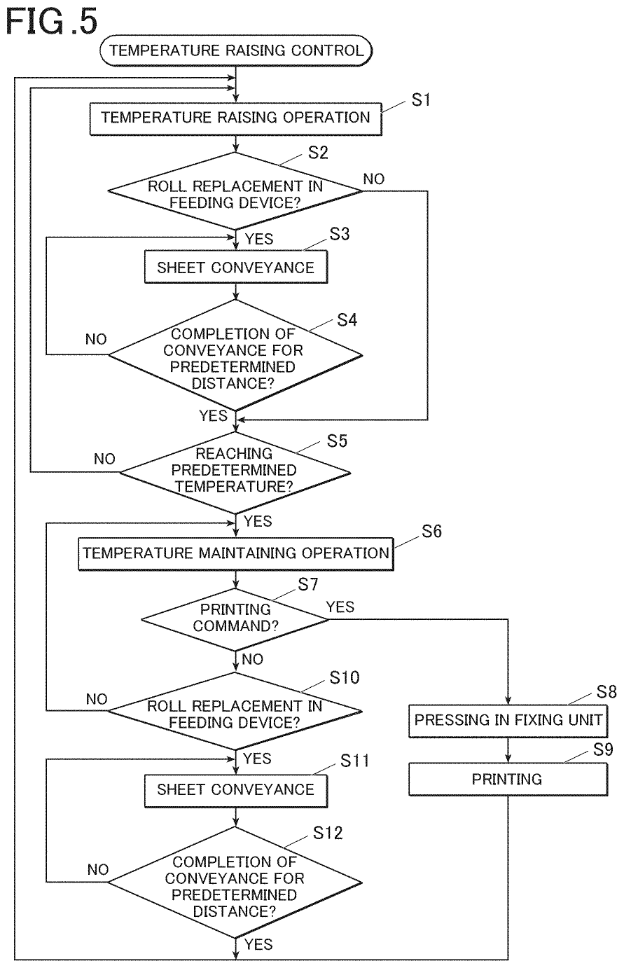

FIG. 5 is a flowchart showing temperature raising control processing performed by the controller 10. The temperature raising control processing shown in FIG. 5 is performed by cooperation of the CPU 10a of the controller 10 and the program stored in the ROM 10b when the image forming apparatus 100 is powered on.

In step S1, the controller 10 performs the temperature raising operation of the fixing unit 60 (step S1).

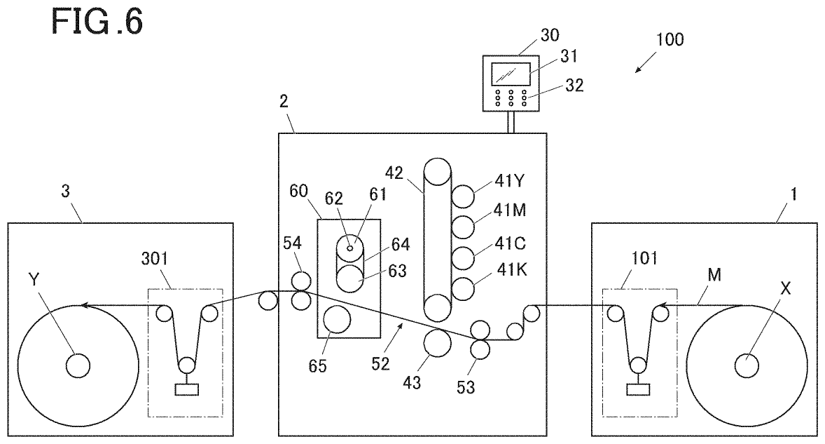

As shown in FIG. 6, the temperature raising operation of the fixing unit 60 includes separation of the transfer rollers 43, separation of the fixing belt 64 and the lower pressure roller 65, and power supply to the heating source 62 during rotation of the fixing belt 64 until the fixing unit 60 becomes a target temperature.

In the present embodiment, the controller 10 performs the temperature raising operation when tension is applied to the continuous medium M by the tension applying mechanism 101 and the tension applying mechanism 301 and when the roller nips 53, 54 are in respective pressing states.

As described above, when the image forming apparatus 100 is powered on, the tension applying mechanism 101 and the tension applying mechanism 301 applies tension to the continuous medium M, however, when the image forming apparatus 100 is powered off, the tension applying mechanism 101 and the tension applying mechanism 301 do not apply tension to the continuous medium M. Therefore, immediately after the power is turned on, the continuous medium M may be sagging. Therefore, immediately after the power is turned on, the continuous medium M is slowly conveyed and tension is applied to the continuous medium M by the tension applying mechanism 101 and the tension applying mechanism 301, and then the temperature raising operation is performed. When the roller nips 53, 54 are in respective separating states, both the roller nips 53, 54 come into the respective pressing states and the temperature raising operation in response to tension that is applied to the continuous medium M.

By the tension applied to the continuous medium M, the continuous medium M is pulled in the sheet conveyance direction and can be separate from the fixing belt 64. If the distance between the fixing belt 64 and the continuous medium M can be maintained, it is possible to reduce the scratch of the fixing belt 64 due to the contact of the continuous medium M and the rotating fixing belt 64. Therefore, it is possible to suppress the image quality deterioration due to the scratch on the fixing belt.

Further, by keeping the pressing states of the roller nips 53, 54, the tension applied to the continuous medium M between the roller nip 53 and the roller nip 54 is maintained even when the conveyance of the continuous medium M is stopped. That is, even when the continuous medium M is stopped and the tension by the tension applying mechanisms 101, 301 is relaxed, the tension of the continuous medium M can be maintained between the roller nip 53 and the roller nip 54. Therefore, for example, when the continuous medium M is cut after printing and the printed matter is taken out or when the roll of the continuous medium M is replaced, the fixing belt 64 and the continuous medium M can be separate from each other even when the tension is relaxed. As a result, it becomes possible to continue the temperature raising operation and the temperature maintaining operation of the fixing unit 60, and to shorten the waiting time for the temperature raising operation of the fixing unit 60 after cutting the continuous medium after printing to take out the printed matter or after replacing the continuous medium on the paper feeding side.

The temperature raising operation may be performed while conveyance (movement) of the continuous medium M is stopped or continued, unless conveyance of the continuous medium M has to be stopped for taking out printed materials, replacing a roll, and the like.

When the continuous medium M is stopped while the roller nips 53, 54 are in respective pressing states, the continuous medium M may be stretched or deformed due to the heat generated in the fixing unit 60. Then, the applied tension is decreased, and it becomes difficult to maintain the distance between the fixing belt 64 and the continuous medium M. Therefore, when the temperature raising operation is performed while the continuous medium M is stopping, it is preferred that the upstream roller nip 53 that are in a pressing state hold the continuous medium M, and that a driving torque to pull the continuous medium M in a downstream direction is applied to the downstream roller nip 54 that are in a pressing state to send the continuous medium M to the downstream side. As a result, the tension can be maintained even when the continuous medium M is deformed or stretched, and the expansion and contraction due to the deformation can be absorbed. Therefore, the continuous medium M can be away from the fixing belt 64, and can avoid contact.

On the other hand, when the temperature raising operation is performed while the roller nips 53, 54 rotate so as to convey the continuous medium M, the continuous medium M does not stay in one place, and the deformation thereof can be suppressed. Moreover, since the tension between the roller nip 53 and the roller nip 54 is also kept constant by the conveyance, the expansion and contraction of the continuous medium M can be absorbed.

Next, the controller 10 determines whether or not a roll of the continuous medium M has been replaced in the feeding device 1 (step S2).

When replacing the roll of the continuous medium M in the feeding device 1, the user performs replacement by operating the operation unit 32 to give a command to replace the continuous medium M. When the replacement is completed, the user operates the operation unit 32 to press a replacement completion button. The controller 10 determines whether or not the continuous medium M roll has been replaced, based on whether or not the replacement completion button has been pressed. The replacement of the roll includes bonding and connecting the continuous medium M of the roll used before the replacement and the continuous medium M of the roll used after the replacement.

If it is determined that the roll of the continuous medium M has been replaced (step S2; YES), the controller 10 controls the feeding device 1, the sheet conveyer 50, and the winding device 3 to convey the continuous medium M (step S3). When conveyance of the continuous medium M for a predetermined distance is completed (step S4; YES), the process proceeds to step S5.

When the roll of the continuous medium M is replaced in the feeding device 1, the connected portion of the continuous media M (a portion where the continuous medium M of the roll used before replacement and the continuous medium M of the roll used after replacement are bonded together) exists on the upstream side of the fixing unit 60. Because the connecting portion often has wrinkle or deformation, when the connecting portion reaches the fixing nip portion of the fixing unit 60, the distance between the fixing belt and the medium cannot be maintained, and the continuous medium M contacts the fixing belt 64. As a result, the fixing belt 64 is scratched and the image quality is deteriorated. Therefore, when the roll of the continuous medium M has been replaced, the continuous medium M is conveyed for a predetermined distance. The predetermined distance is determined in advance and is a distance that allows at least the connecting portion to pass through the position of the fixing nip portion of the fixing unit 60.

In this way, by conveying the continuous medium M such that the connected portion is at the downstream side of the fixing nip portion of the fixing unit 60 after replacement of the roll on the paper feeding side, the occurrence of scratches on the fixing belt 64 can be suppressed.

If it is determined that the roll of the continuous medium M has not been replaced (step S2; NO), the process proceeds to step S5.

In step S5, the controller 10 refers to a temperature sensor (not shown) and determines whether the fixing unit 60 has reached a predetermined temperature (target temperature) (step S5). If it is determined that the fixing unit 60 has not reached a predetermined temperature (step S5; NO), the process returns to step S1.

If it is determined that the fixing unit 60 has reached a predetermined temperature (step S5; YES), the controller 10 performs the temperature maintaining operation of the fixing unit 60 (operation of maintaining the temperature raised state) (step S6).

While electric power is supplied to the heating source 62 until it becomes the target temperature in the temperature raising operation, the electric power supply of the heating source 62 is turned ON/OFF to maintain the target temperature in the temperature maintaining operation. The other operations (i.e., separation of the fixing belt 64 and the lower pressure roller 65, rotation of the fixing belt 64, application of tension to the continuous medium M, pressing of the roller nips 53, 54, and the like) are the same as those described in step S1, and thus the description is omitted.

Next, the controller 10 determines whether or not there is a command to form an image (printing command) (step S7). If it is determined that there is a command to form an image (step S7: YES), the controller 10 presses the upper pressure roller 63 and the lower pressure roller 65 to each other to form a fixing nip (step S8), prints on the continuous medium M, that is, forms a toner image on the continuous medium M by the image former 40, and conveys the continuous medium M until the toner image formed by the image former 40 is fixed by the fixing unit 60 and is conveyed to the downstream side of the fixing unit 60 (step S9). The process then returns to step S1.

On the other hand, if it is determined that there is not a command to form an image (step S7: NO), the controller 10 determines whether or not the continuous medium M roll has been replaced in the feeding device 1 (step S10).

If it is determined that the roll of the continuous medium M has not been replaced (step S7: NO), the process returns to step S6.

If it is determined that the roll of the continuous medium M has been replaced (step S10; YES), the controller 10 controls the feeding device 1, the sheet conveyer 50, and the winding device 3 to convey the continuous medium M (step S11). When the continuous medium M is conveyed for a predetermined distance (step S12; YES), the process returns to step S1. The processes of steps S10 to S12 are the same as those of steps S2 to S4, and thus the description is omitted. While the image forming apparatus 100 is powered on, the controller 10 repeatedly performs steps S1 to S12.

In this way, in the image forming apparatus 100, the temperature raising operation and the temperature maintaining operation are performed while the tension applying mechanisms 101, 301 apply tension to the continuous medium M and while the roller nips 53, 54 are in respective pressing states. Therefore, the tension applied to the continuous medium M between the roller nip 53 and the roller nip 54 can be maintained even if application of tension is stopped when cutting the continuous medium M after printing and the printed matter is taken out or when changing the roll of the continuous medium M on the paper feeding side. Therefore, because the continuous medium M can be separate from the fixing belt 64, it is possible to continue the temperature raising operation and the temperature maintaining operation of the fixing unit 60. As a result, it is possible to shorten the waiting time for the temperature raising operation for reprinting after cutting the continuous medium M after printing to take out the printed matter or after replacing the continuous medium M on the paper feeding side.

### Second Embodiment

Next, a second embodiment of the present invention will be described.

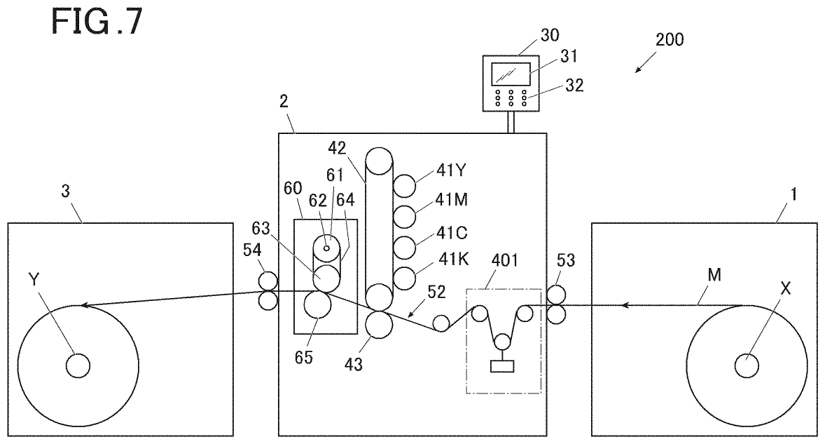

In the first embodiment, an example in Which the feeding device 1 and the winding device 3 are respectively provided with the tension applying mechanism 101 and the tension applying mechanism 301 has been described. In the image forming apparatus 200 of the second embodiment, as shown in FIG. 7, a tension applying mechanism 401 is provided between the roller nip 53 and the roller nip 54 respectively on the upstream side and the downstream side of the fixing unit 60. The structure of the tension applying mechanism 401 is similar to that of the tension applying mechanisms 101, 301 described above.

Although FIG. 7 illustrates an example in which the tension applying mechanism 401 is provided on the upstream side of the fixing unit 60 and between the roller nip 53 and the roller nip 54, it may be provided on the downstream side of the fixing unit 60. Further, the feeding device 1 and the winding device 3 may be each provided with a tension applying mechanism.

The other configurations of the respective units and the operation of the temperature raising control processing of the image forming apparatus 200 are the same as those described in the first embodiment, and thus the description thereof will be omitted.

In the image forming apparatus 200 shown in FIG. 7, the continuous medium M feeds out from the feeding device 1, passes through the roller nip 53, is tensioned by the tension applying mechanism 401, is subjected to toner image transfer at the transfer roller 43, is subjected to toner image fixtion at the fixing unit 60, and is wound up by the winding device 3. When the roller nips 53, 54 are in respective pressing states, the tension of the continuous medium M on the upstream side of the roller nip 53 can be applied by the torque of the rotation shaft X of the feeding device 1. The tension of the continuous medium M on the downstream side of the roller nip 54 can be applied by the torque of the rotation shaft Y of the winding device 3. The tension of the continuous medium M between the roller nip 53 and the roller nip 54 can be applied by the tension applying mechanism 401. When the roller nips 53, 54 are in respective separating states, the tension applying mechanism 401 can apply a constant tension to the continuous medium M from the rotation shaft X of the feeding device 1 to the rotation shaft Y of the winding device 3.

According to the image forming apparatus 200, the tension applying mechanism 401 is provided between the upstream roller nip 53 and downstream roller nip 54. Therefore, by causing both the roller nips 53, 54 to be in respective pressing states during the temperature raising operation and the temperature maintaining operation, the tension of the continuous recording medium M can be maintained between the roller nip 53 and the roller nip 54 even when the continuous medium M is stopped and the tension is relaxed in the feeding device 1 or the winding device 3. Therefore, even after cutting the continuous medium after printing to take out the printed matter or after replacing the continuous medium M, the continuous medium M can be separate from the fixing belt 64, and it is possible to continue the temperature raising operation and the temperature maintaining operation of the fixing unit 60. As a result, it is possible to shorten the waiting time for the temperature raising operation after cutting the continuous medium after printing to take out the printed matter or after replacing the continuous medium M on the paper feeding side.

Further, a tension applying mechanism 401 is provided between the roller nip 53 and the roller nip 54. Therefore, even if the continuous medium M is stretched or deformed because of the heat generated during the temperature raising operation or the temperature maintaining operation of the fixing unit 60, the tension of the continuous medium M can be continuously applied without decreasing, and the fixing belt 64 and the continuous medium M can keep being separate from each other.

The first embodiment and the second embodiment of the present invention have been described above, but the description in the above embodiment is an example of a suitable image forming apparatus according to the present invention, and the present invention is not limited to this.

For example, in the example described in the first and second embodiments, a nip portion provided on the upstream side of the fixing unit 60 and the downstream side of the feeding device 1, and a nip portion provided on the downstream side of the fixing unit 60 and the upstream side of the winding device 3 are respective pairs of nip rollers (roller nip 53, roller nip 54). However, the nip portions may be each configured by a pair of pressurizing members that can be in a pressing state and in a separating state (pressurizing members that do not rotate). Then, the controller 10 may control the pressing drive mechanism of the pressurizing members such that both the upstream nip portions and the downstream nip portions are in respective separating states during the conveyance of the continuous medium M. During the temperature raising operation or the temperature maintaining operation, the controller 10 may stop the continuous medium M while tension is applied to the continuous medium M, such that the nip portions on both the upstream side and the downstream side are in respective pressing states.

Alternatively, the upstream nip portion may be a pressurizing member, and the downstream nip portion may be the roller nip 54. During the temperature raising operation or the temperature maintaining operation, the upstream nip portion in a pressing state holds the continuous medium M, and a driving torque to pull the continuous medium M in a downstream direction is applied to the downstream roller nip 54 that is in a pressing state to send the continuous medium M to the downstream side.

However, the above-mentioned nip portions are preferably the roller nips 53, 54 because they can convey the continuous medium M. In particular, when the continuous medium M is conveyed only and fixing is not performed, the continuous medium M takes away the heat accumulated in the fixing unit 60 in the conveyance performed using the fixing nip of the fixing unit 60. As a result, after conveyance, it takes time to raise the temperature to store heat to the target temperature required for printing. However, if there are respective pairs of nip rollers at the upstream side and the downstream side of the fixing unit 60, it is not necessary to use the fixing nip of the fixing unit 60 in conveyance of the continuous medium M. Further, it is possible to perform the temperature raising operation and the temperature maintaining operation even during the conveyance of the continuous medium M.

When the continuous medium M is conveyed in a state where the upper pressure roller 63 and the lower pressure roller 65 of the fixing unit 60 are in a pressing state (for example, when the continuous medium M on which an image is formed is conveyed), the controller 10 preferably controls at least the roller nip 54 on the downstream side of the fixing unit 60 are in a separating state.

In order to apply tension to the continuous medium M using a plurality of pairs of nip rollers, it is generally known that the linear rate of a pair of nip rollers on the downstream side is set higher than the linear rate of a pair of nip rollers on the upstream side. That is, when there is a pair of nip rollers at the downstream side of the fixing unit 60, it is preferable to make the linear rate of the pair of nip rollers higher than the linear rate of the fixing nip formed in the fixing unit 60. However, since the nip pressure at the fixing nip is generally much larger than the nip pressure(s) of the other pair(s) of nip rollers, when the linear rate of the downstream roller nip is high, the downstream nip roller pair is loaded and slips. As a result, the image surface and the paired nip rollers are rubbed with each other, which may cause an image defect. Therefore, when the continuous medium M is conveyed in a state where the upper pressure roller 63 and the lower pressure roller 65 of the fixing unit 60 are in a pressing state, the controller 10 makes at least the roller nip 54 on the downstream side of the fixing unit 60 are in a separating state, such that the occurrence of slippage at the roller nip 54 can be suppressed and the occurrence of image defects can be avoided.

In the example described in the above embodiments, the fixing unit 60 is configured to use the fixing belt 64, but a fixing belt may not be used in the present invention. Instead of the fixing belt, the upper pressure roller may be used as a first rotating member, the lower pressure roller may be used as a second rotating member, and the first rotating member and the second rotating member may directly press each other in the fixing unit. In this case, for example, a heating source is provided near the upper pressure roller that is the first rotating member, and the temperature raising operation and the temperature maintaining operation are performed while the upper pressure roller is rotating.

In the above-described embodiments, the image forming apparatus 100, 200 is a color image forming apparatus that sequentially transfers the toner images on the photoreceptor to an intermediate transfer body, but may be a monochrome image forming apparatus that forms an image with a single color toner.

Further, in the above-described embodiment, an example in which a semiconductor memory or HDD is used as a computer-readable medium that stores a program for executing each process is disclosed, but the invention is not limited to this example. It is also possible to apply a portable recording medium such as a CD-ROM as another computer-readable medium. Moreover, a carrier wave may be applied as a medium for providing the program data via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that forms an image on a continuous medium fed from a sheet feeder, fixes the image by a fixing unit, and winds the continuous medium at a winder,
the fixing unit having a first rotating member and a second rotating member, the first rotating member being provided on a fixing surface side of the continuous medium, the second rotating member facing the first rotating member across a sheet passing path of the continuous medium,
the first rotating member being set to be separate from the continuous medium in the sheet passing path in response to tension applied to the continuous medium while the first rotating member is separate from the second rotating member,
the image forming apparatus comprising:
a tension applying mechanism that applies tension to the continuous medium;
at least one paired upstream nip portion arranged at an upstream side of the fixing unit and at a downstream side of the sheet feeder in the sheet passing path;
at least one paired downstream nip portion arranged at a downstream side of the fixing unit and at an upstream side of the winder in the sheet passing path; and
a controller that separates the first rotating member from the second rotating member while tension is applied to the continuous medium, rotates the first rotating member, and performs a temperature raising operation and a temperature maintaining operation of the first rotating member,
wherein, during the temperature raising operation and the temperature maintaining operation, the controller causes the upstream nip portion to be in a pressing state and the downstream nip portion to be in a pressing state and maintains tension that is applied to the continuous medium between the upstream nip portion and the downstream nip portion.

2. The image forming apparatus according to claim 1, wherein, in the sheet passing path, in response to tension applied to the continuous medium while the first rotating member is separate from the second rotating member, the continuous medium is set to be wound around the second rotating member.

3. The image forming apparatus according to claim 1, wherein the tension applying mechanism is arranged between the upstream nip portion and the downstream nip portion.

4. The image forming apparatus according to claim 1, wherein
the upstream nip portion and the downstream nip portion are each a pair of rollers, and
the controller rotates the pair of rollers and conveys the continuous medium.

5. The image forming apparatus according to claim 1, wherein
the downstream nip portion is a pair of rollers, and
the controller causes the upstream nip portion to hold the continuous medium upon stop of the continuous medium and causes a torque that sends the continuous medium in a downstream direction to be applied to the pair of rollers of the downstream nip portion that is in a pressing state, such that tension is applied to the continuous medium between the upstream nip portion and the downstream nip portion.

6. The image forming apparatus according to claim 4, wherein
the controller causes the pair of rollers of at least the downstream nip portion to be in a separating state upon conveyance the continuous medium using a nip of the fixing unit.

7. The image forming apparatus according to claim 1, wherein,
upon replacement of a roll in the sheet feeder, the controller restarts the temperature raising operation after the continuous medium is conveyed for predetermined distance.
